(19) United States
(12) Patent Application Publication
(10) Pub. No.: US 2026/0080723 A1
(43) Pub. Date: Mar. 19, 2026

(54) SLEEP STATE MONITORING FOR VEHICLES

(71) Applicant: Rivian IP Holdings, LLC, Irvine, CA (US)

(72) Inventors: Tejas Abhay CHAFEKAR, Edwards, IL (US); Thomas Rocroi, Richmond, CA (US); Won Tae Joe, Lake Forest, CA (US); Randy Long, Irvine, CA (US)

(21) Appl. No.: 19/242,854

(22) Filed: Jun. 18, 2025

Related U.S. Application Data
(60) Provisional application No. 63/694,674, filed on Sep. 13, 2024.

(51) Int. Cl. G07C 5/00; B60L 58/10; B60R 16/023

(52) U.S. Cl. CPC G07C 5/008; B60R 16/0231; B60L 58/10

(57) ABSTRACT

Monitoring for thermal events in a vehicle may be provided while the vehicle is in a sleep mode. The monitoring may be performed by periodically switching one of several processing cores of an electrical control unit (ECU) of the vehicle to a run or wake state to obtain and analyze sensor data. A duty cycle for the periodic wakeups of the one of the several processing cores may be determined based on a balancing of an amount of time for sensing and analyzing the sensor data, a time corresponding to a characteristic feature of a thermal event, and/or a power constraint associated with the sleep mode of the vehicle.

### CROSS REFERENCE TO RELATED APPLICATIONS

This application claims the benefit of priority to U.S. Provisional Ser. No. 63/694,674, entitled, “Sleep State Monitoring for Vehicles”, filed on Sep. 13, 2024, the disclosure of which is hereby incorporated herein in its entirety.

### INTRODUCTION

Vehicles are often provided with sensors for sensing aspects of the vehicle's operation and/or condition during operation of the vehicle. These sensors are typically disabled or off when the vehicle is not in operation.

### SUMMARY

In accordance with aspects of the subject disclosure, a method is provided that includes setting, responsive to a vehicle entering a sleep mode, first and second processing cores of an electronic control unit of the vehicle to a sleep state; waking the first processing core to a run state from the sleep state without waking the second processing core to the run state for a first fraction of a time interval during which the vehicle is in the sleep mode; determining, by the first processing core during the first fraction of the time interval and based on sensor data from a sensor of the vehicle, whether a thermal event is occurring in the vehicle; and returning the first processing core from the run state to the sleep state for a remaining second fraction of the time interval during which the vehicle is in the sleep mode. The time interval may be at least ten times smaller than a known duration of a thermal event signature in the sensor data.

The sensor may include a pressure sensor, and the thermal event signature may include a pressure variation signature associated with the thermal event. The first fraction may be less than ten percent of the remaining second fraction. The time interval may be based on the known duration and a sleep mode power budget for the sleep mode of the vehicle. The first fraction may be based on the sleep mode power budget, a first time allocation for communicating with the sensor, a second time allocation for processing the sensor data, and a third time allocation for performing detection operations using the processed sensor data.

The method may also include waking the second processing core to an idle state from the sleep state for the first fraction of the time interval during which the vehicle is in the sleep mode; and returning the second processing core from the idle state to the sleep state for the remaining second fraction of the time interval during which the vehicle is in the sleep mode. The method may also include waking a third processing core to the idle state from the sleep state for the first fraction of the time interval during which the vehicle is in the sleep mode; and returning the third processing core from the idle state to the sleep state for the remaining second fraction of the time interval during which the vehicle is in the sleep mode.

The method may also include, responsive to determining, by the first processing core during the first fraction of the time interval and based on sensor data from the sensor of the vehicle, that the thermal event is occurring in the vehicle, providing an alert from the vehicle to a device of a user.

In accordance with other aspects of the subject disclosure, an electronic control unit for a vehicle is provided, the electronic control unit including: a first processing core; and a second processing core. The first and second processing cores may be configured to enter a sleep state responsive to the vehicle entering a sleep mode. The first processing core may be configured to: enter a run state from the sleep state without waking the second processing core to the run state for a first fraction of a time interval during which the vehicle is in the sleep mode; determine, during the first fraction of the time interval and based on sensor data from a sensor of the vehicle, whether a thermal event is occurring in the vehicle; and return from the run state to the sleep state for a remaining second fraction of the time interval during which the vehicle is in the sleep mode. The time interval may be at least ten times smaller than a known duration of a thermal event signature in the sensor data. The sensor may include a pressure sensor, and the thermal event signature may include a pressure variation signature associated with the thermal event. The first fraction may be less than ten percent of the remaining second fraction. The time interval may be based on the known duration and a sleep mode power budget for the sleep mode of the vehicle. The first fraction may be based on the sleep mode power budget, a first time allocation for communicating with the sensor, a second time allocation for processing the sensor data, and a third time allocation for performing detection operations using the processed sensor data. The second processing core may be configured to: transition to an idle state from the sleep state for the first fraction of the time interval during which the vehicle is in the sleep mode; and return from the idle state to the sleep state for the remaining second fraction of the time interval during which the vehicle is in the sleep mode. The electronic control unit may also include a third processing core, the third processing core configured to: transition to the idle state from the sleep state for the first fraction of the time interval during which the vehicle is in the sleep mode; and return from the idle state to the sleep state for the remaining second fraction of the time interval during which the vehicle is in the sleep mode. At least one of the first processing core, the second processing core or a third processing core of the electronic control unit may be configured to: responsive to determining, by the first processing core during the first fraction of the time interval and based on sensor data from the sensor of the vehicle, that the thermal event is occurring in the vehicle, provide an alert for transmission from the vehicle to a device of a user.

In accordance with other aspects of the subject disclosure, an electric vehicle is provided that includes an electronic control unit that includes: a first processing core; and a second processing core. The first and second processing cores may be configured to enter a sleep state responsive to the electric vehicle entering a sleep mode. The first processing core may be configured to: enter a run state from the sleep state without waking the second processing core to the run state for a first fraction of a time interval during which the electric vehicle is in the sleep mode; determine, during the first fraction of the time interval and based on sensor data from a sensor of the electric vehicle, whether a thermal event is occurring in the electric vehicle; and return from the run state to the sleep state for a remaining second fraction of the time interval during which the electric vehicle is in the sleep mode. At least one of the first processing core, the second processing core or a third processing core of the electronic control unit may be configured to: responsive to determining, by the first processing core during the first fraction of the time interval and based on sensor data from the sensor of the vehicle, that the thermal event is occurring in the vehicle, provide an alert for transmission from the vehicle to a device of a user.

### BRIEF DESCRIPTION OF THE DRAWINGS

Certain features of the subject technology are set forth in the appended claims. However, for purpose of explanation, several embodiments of the subject technology are set forth in the following figures.

FIGS. 1A and 1B illustrate schematic perspective side views of example implementations of a vehicle in accordance with one or more implementations.

FIG. 2 illustrates a schematic view of processing circuitry for a vehicle in accordance with one or more implementations.

FIG. 3 illustrates a timing diagram for operating one or more processing cores for a vehicle in accordance with one or more implementations.

FIG. 4 is a flow chart of illustrative operations that may be performed for sleep state monitoring for vehicles in accordance with one or more implementations.

FIG. 5 illustrates an example computing system with which aspects of this disclosure may implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Vehicles are often left parked in parking lots, parking garages, and along streets, sometimes for hours or days at a time. Parked vehicles are typically left in an off or sleep state in which most, if not all, of the mechanical or electrical systems of the vehicle are also off or in a standby state. This can reduce the power consumed while the vehicle is in the sleep or off state, which can be particularly beneficial for electric vehicles that are propelled by electrical power. However, it can also be advantageous to be able to monitor various systems and/or characteristics of the vehicle, even when the vehicle is in an off or sleep state. As one illustrative example, it can be beneficial to monitor a battery of a vehicle to detect a thermal event that could, if not monitored, cause damage to the battery, the vehicle, and/or surrounding structures.

Aspects of the subject technology can provide monitoring (e.g., for thermal events) in a vehicle (e.g., in a vehicle battery or battery pack), while the vehicle is in a sleep mode. In one or more implementations, the monitoring may be performed by periodically switching one of several processing cores of an electrical control unit (ECU) of the vehicle to a run or wake state to obtain and analyze sensor data. In particular, the one of the several processing cores can be switched from a sleep state to a run state, while one or more other processing cores remain in the sleep state or switch from the sleep state to an idle state. As discussed in further detail hereinafter, a duty cycle for the periodic wakeups of the one of the several processing cores may be determined based on a balancing of an amount of time for sensing and analyzing the sensor data, a time corresponding to a characteristic feature of a thermal event, and/or a power constraint associated with the sleep mode of the vehicle.

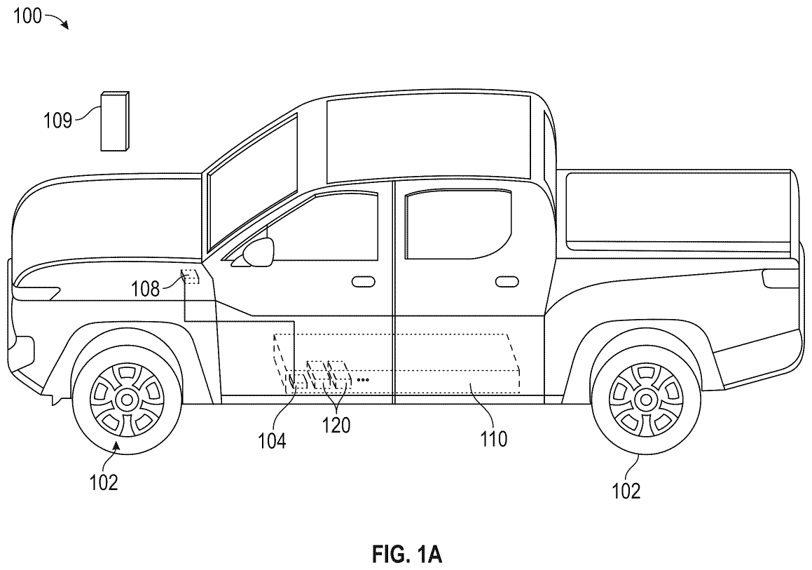

FIG. 1A is a diagram illustrating an example implementation of an apparatus as described herein. In the example of FIG. 1A, the apparatus is a moveable apparatus implemented as a vehicle 100. In one or more implementations, the vehicle 100 may be implemented as an electric vehicle and may include one or more batteries 110 for powering the vehicle and/or one or more systems and/or components of the vehicle. As shown, the battery 110 may include one or more battery cells 120.

For example, in one or more implementations, the vehicle 100 may be an electric vehicle having one or more electric motors that drive the wheels 102 of the vehicle using electric power from the battery 110. In one or more implementations, the vehicle 100 may also, or alternatively, include one or more chemically powered engines, such as a gas-powered engine or a fuel cell powered motor. For example, electric vehicles can be fully electric or partially electric (e.g., hybrid or plug-in hybrid).

In the example of FIG. 1A, the vehicle 100 is implemented as a truck (e.g., a pickup truck) having one or more batteries 110 (e.g., a battery pack in which multiple, such as hundreds or thousands of battery cells are disposed), and processing circuitry 108 (e.g., including one or more electronic control units (ECUs) including one or more processors, memory, and/or communications circuitry). As shown, the vehicle 100 may include one or more sensors 104. In the example of FIG. 1A, the sensor 104 is disposed within the battery 110 (e.g., within a battery pack housing in which the battery cells are also disposed). In various examples, the sensor 104 may include a pressure sensor, a temperature sensor, a gas sensor, and/or other sensors or combinations of sensors. In one illustrative example that is discussed herein, the sensor 104 is a pressure sensor.

Thermal events associated with batteries can occur when the vehicle is asleep or in operation. A thermal event may include overheating of one or more battery cells within the battery 110 in some examples. In one or more implementations, when a thermal event occurs, the pressure within the battery (e.g., within the battery pack housing) may increase and/or decrease in a characteristic pressure variation pattern that can be used to (e.g., indirectly) detect the thermal event (e.g., even when no temperature sensors are present or active). In one or more implementations, the characteristic pressure pattern may include one or more increases and/or decreases in pressure that occur over a characteristic time scale (e.g., between one and two seconds, or less than a few seconds).

In order to detect such a transient pressure change within the characteristic time scale, sensing of the pressure using the processing circuitry 108 and the sensor 104 may be performed several (e.g., ten, twenty, or more than twenty) times within each period of time equal to the characteristic time scale. However, sensing of the pressure using the processing circuitry 108 and the sensor 104 also draws power from the battery 110, which can reduce the range of the vehicle 100. Accordingly, the pressure may be sensed using the processing circuitry 108 and the sensor 104 for only a fraction of each of several time intervals within each period of time equal to the characteristic time scale. In one or more implementations, when a thermal event is detected by the processing circuitry 108, the processing circuitry 108 may transmit an alert (e.g., over a wired or wireless connection) to another device 109 (e.g., a portable device) external to the vehicle, such as a smartphone or other electronic device of a user of the vehicle 100.

As examples, the processing circuitry 108 of the vehicle 100 may include electronic control units (ECUs), each of which may include one or more processors (e.g., single processors, multi-core processors, central processing units (CPUs), application-specific integrated circuits (ASICS), field programmable gate arrays (FPGAs) and/or other processing circuits), and/or any of various types of computer-readable and/or machine-readable media (e.g., persistent storage, system memory and/or buffers, volatile memory and/or non-volatile memory). In one or more implementations, the processing circuitry 108 may include input devices, output devices, network interfaces, and/or a bus that communicatively couples the processor(s), the memory, the communications circuitry, the input devices, the output devices, and/or one or more other devices or components (e.g., sensors 104, motion sensors, proximity sensors, etc.). The processor(s) of the processing circuitry 108 may execute instructions stored in the memory of the processing circuitry 108, such as to execute one or more machine learning models (e.g., neural networks, such as deep learning networks, transformer-based models and/or other attention-based models, multi-layer perceptrons or other feed-forward networks) and/or other hardware, firmware, and/or software processes in order to perform the processes of the subject disclosure. In one or more implementations, the processing circuitry 108 may include a multi-core processor having two, three, or more than three processing cores.

The example of FIG. 1A, in which the vehicle 100 is implemented as a pickup truck having a truck bed, is merely illustrative. For example, FIG. 1B illustrates another implementation in which the vehicle 100 including the battery 110, the sensors 104 and the processing circuitry 108 is implemented as a sport utility vehicle (SUV), such as an electric sport utility vehicle. In the example of FIG. 1B, the vehicle 100 including the battery 110, the sensors 104, and the processing circuitry 108 may include a cargo storage area in at least a rear portion of the vehicle that is enclosed within the vehicle 100 (e.g., behind a row of seats within a cabin of the vehicle). In other implementations, the vehicle 100 may implemented as another type of electric truck, an electric delivery van, an electric automobile, an electric car, an electric motorcycle, an electric scooter, an electric passenger vehicle, an electric passenger or commercial truck, a hybrid vehicle, or other vehicles such as sea or air transport vehicles, planes, helicopters, submarines, boats, or drones, and/or any other movable apparatus having sensors 104 and the processing circuitry 108. In one or more implementations, the vehicle 100 may have an active (e.g., drive) mode in which a high voltage power source (e.g., the battery 110) is ready to drive the motor(s) of the vehicle 100, and a sleep mode in which the motor(s) of the vehicle, and/or one or more electronic systems (e.g., radio systems, speedometer systems, navigation systems, lighting systems, audio systems, display systems, etc.) of the vehicle are inactive or disabled.

In one or more implementations, the battery 110, the sensors 104, and the processing circuitry 108 as described herein may also, or alternatively, be implemented in another apparatus, such as a building (e.g., a residential home or commercial building, or any other building) or other stationary apparatus.

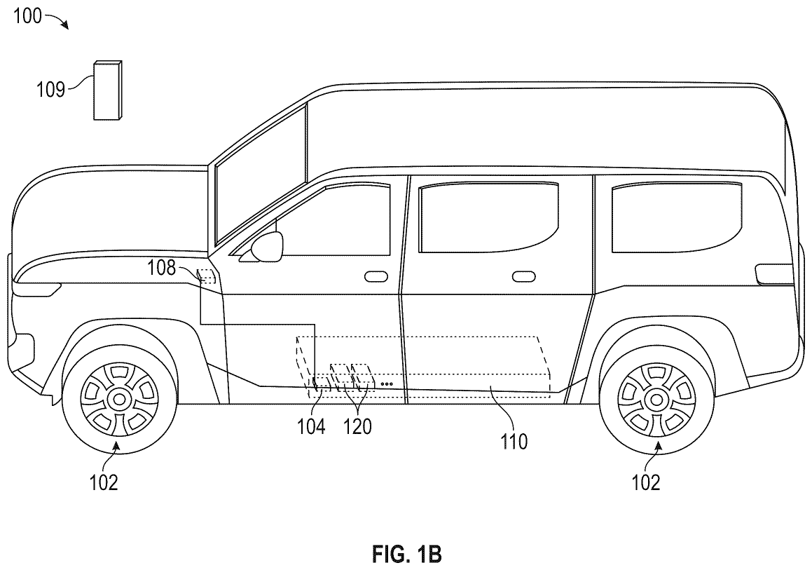

FIG. 2 depicts a view of example of an electronic control unit 201 that may be included in the processing circuitry 108 of FIGS. 1A and 1B. As shown, the electronic control unit (ECU) 201 may include multiple processing cores, such as a processing core 200, a processing core 202, and a processing core 204. As one illustrative example, the electronic control unit may include an Aurix™ TC3x microcontroller power management system. In one or more implementations, each of the processing core 200, the processing core 202, and the processing core 204 may be transitionable between multiple available power states or modes. For example, the multiple available power states may include a run state in which all aspects of the processing core are available and active, an idle state in which, for example, a CPU clock is disabled, Direct Memory Interface and/or Program Memory Interface (DMI/PMI) memories are accessible, and peripherals remain active, a sleep state in which peripheral clocks are gated and the CPU is disabled, and a standby (e.g. lowest power) state in which the main domain is powered off (e.g., and standby RAM may be active).

In one or more implementations, the processing core 200 may host software to obtain and process sensor data (e.g., pressure sensor data) and detect thermal events based on the sensor data. In one or more implementations, the processing core 202, and/or the processing core 204 may host other (e.g., unrelated to sensor monitoring) software components for the vehicle 100. In one or more implementations, the processing core 200, the processing core 202, and/or the processing core 204 may be transitioned between multiple power states for particular amounts of time to allow monitoring of the vehicle 100 (e.g., using sensor(s) 104) when the vehicle is in the sleep mode without violating a power budget for the ECU 201 in the sleep mode of the vehicle.

In one or more implementations, vehicle architecture sensors may be used to detect thermal events when the vehicle is in a run or “on” mode. For example, a thermal event in a vehicle may be thermal runaway event in a one or more battery cells of a battery generate more heat than can be dissipated. For example, a thermal runaway event may result from a self-sustaining chemical reaction that occurs in a battery cell. It may be desirable to be able to detect such a thermal event, as the thermal event is occurring, so that the vehicle operation may be changed or disabled, and/or an alert can be provided to a driver and/or other user of the vehicle.

However, typical vehicle architecture sensors that may be used to detect thermal events when the vehicle is in a run or “on” mode are not active when the vehicle is sleeping. In addition, the ECU (e.g., battery management system (BMS)) that performs thermal event detection based on sensed data is also not active in the vehicle sleep mode. In these architectures, in a scenario in which a thermal event occurs when the vehicle is sleeping (and/or parked, such as in a garage), the thermal event may go undetected and a user may not be notified to take any mitigating actions. In accordance with aspects of the disclosure, the risk of undetected thermal events can be reduced or minimized by enabling thermal event detection all the time (e.g., even when vehicle is sleeping). In one or more implementations, this sleep state monitoring can be achieved by adding sensors to the vehicle that remain active in low power modes of the vehicle, and that can interrupt the ECUs and wake up the vehicle under a thermal event. However, adding such hardware sensors can undesirably add cost, complexity, and/or power reduction to a vehicle system.

In accordance with aspects of the disclosure, innovative operation of existing vehicle hardware can be used to achieve monitoring (e.g., thermal event detection) in vehicle sleep while meeting vehicle level power budgets. The sleep state monitoring disclosed herein may be agnostic to the hardware and/or sensors that are performing the monitoring (e.g., the sensing for thermal events) and can be extended to multiple programs and/or product lines without additional hardware cost. The sleep state monitoring disclosed herein may be applied to existing vehicles via an over-the-air (OTA) update without requiring physical servicing of vehicles.

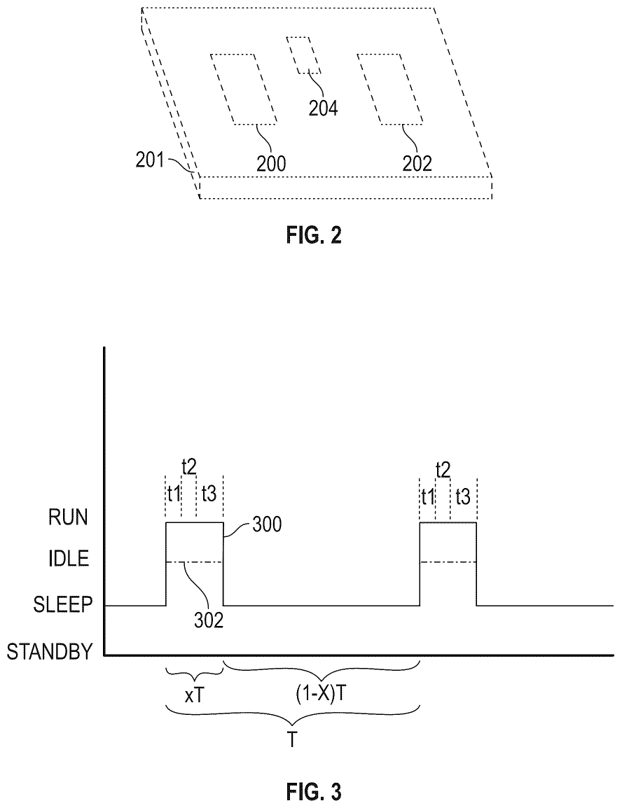

In one or more implementations, the sleep state monitoring disclosed herein may include microcontroller core duty cycling, as indicated in FIG. 3. For example, FIG. 3 may indicate the power states of the processing core 200, the processing core 202, and the processing core 204 during a time in which the vehicle 100 is in a sleep mode. For example, at other times (e.g., not depicted in FIG. 3) when the vehicle 100 is awake or active, the processing core 200, the processing core 202, and the processing core 204 may all be configured to operate in the RUN state (e.g., normal operation). As shown in the example of FIG. 3, when the vehicle 100 is in a sleep mode, the processing core 200, the processing core 202, and the processing core 204 may duty cycle between RUN/IDLE and SLEEP states (e.g., without any of the processing cores entering the lowest power STANDBY state).

For example, as shown in FIG. 3, the timeline 300 may correspond to the power state of the processing core 200, and the timeline 302 may correspond to the power states of the processing core 202 and the processing core 204. As shown, the processing core 200 may periodically enter the RUN state and return to the SLEEP state. For example, the processing core 200 may enter the RUN state for a first fraction, xT, of each time interval T, and may return to the SLEEP state for a remaining second fraction (1-x)T of the time interval T. For example, when the processing core 200 is in the RUN state, it can communicate with the sensor(s) 104 to obtain sensor data, process the sensor data, and determine whether a thermal event is occurring. As shown by the timeline 302, the processing core 202 and the processing core 204 may enter the IDLE state for the first fraction, xT, of each time interval T (e.g., when the processing core 200 is in the RUN state), and may return to the SLEEP state for the remaining second fraction (1-x)T of the time interval T (e.g., when the processing core 200 is also in the SLEEP state). In the present discussion, x may represent a number less than one that corresponds to the fraction of the time the cores are in the RUN/IDLE states. In this example, none of the processing cores enter the STANBY state. For example, the transition from the SLEEP state to the RUN state may be faster that the transition from the STANDBY state to the RUN state, and hence the cores may be put into the SLEEP state rather than the STANDBY state to facilitate efficient sleep state monitoring for the vehicle 100. In one or more implementations, rather than transitioning to the IDLE state during the times xT, the processing core 202 and the processing core 204 may remain the SLEEP STATE for the entire time period, T.

In one or more implementations, the time interval, T, may be selected to be sufficiently small relative to a known duration of a thermal event signature in the sensor data from the sensor(s) 104. For example, it is noted that a thermal event in a battery, such as the battery 110, may cause a change in pressure within the battery (e.g., within a battery pack containing multiple battery cells). For example, when a thermal event occurs, the pressure may vary (e.g., one or more pressure increases and/or decreases may occur) in a characteristic way that can be detected using a pressure sensor. In one or more implementations, the pressure variation may occur over a known duration of, for example, one second, two seconds, or several seconds. In one or more implementations, the time interval, T, may be selected such that multiple distinct measurements of the pressure can be obtained during the known duration of the pressure change (e.g., so that the characteristic increases and/or decreases can be observed in the pressure data, such as to distinguish from pressure changes due to other causes, and so that short duration signature features are not missed between intervals). For example, the time interval, T, may be at least ten times smaller, fifteen times smaller, or twenty times smaller than the known duration of a thermal event signature in the sensor data (e.g., so that ten, fifteen, or twenty pressure measurements can be obtained for every thermal event signature time scale). For example, the time interval, T, may be based on the known duration and a sleep mode power budget for the sleep mode of the vehicle (e.g., so that a sufficient number of pressure measurements can be made to detect the pressure variation, while meeting one or more constraints of the sleep mode power budget).

The time, xT, during which the cores remain in the RUN/IDLE states as shown in FIG. 3, versus the time, (1-x)T, during which the cores are in the SLEEP state, may also be tuned considering, for example, the overall vehicle level power budgets to the ECU when the vehicle is in a sleep mode. For example, the duty cycle (e.g., the value of x) may be selected to ensure that an overall power budget is met for the vehicle in the sleep mode, and that the processing core 200 is able to, when processing core is in the RUN state, obtain the sensor data during a time allocation, t1, process the data from the sensor during a time allocation t2, and perform thermal event detection using the sensor data (e.g., the processed sensor data from within the time allocations t1 and/or t2, and/or sensor data from one or more other time intervals, T) during a time allocation t3. For example, the processing core 200 may draw between one and three Watts (W) of power when in the RUN state, the processing core 202 may draw between one hundred and one hundred forty milliAmps (mA) at five Volts (V) in the IDLE state, and the processing core 204 may draw between fifty and ninety mA at five V in the IDLE state. In the SLEEP state, the processing core 200, the processing core 202, and the processing core 204 may draw between 0.1 and 0.3 W. In order to meet a particular power budget threshold (e.g., less than between two hundred and five hundred mW), the total power draw for the sleep state monitoring illustrated in FIG. 3 may be estimated as a power draw equal to x*(on-state-power-draw)+(1-x)*(off-state-power-draw). In some examples, the first fraction, xT, of the time interval, T, may be less than ten percent of the remaining second fraction (1-x)T, less than eight percent of the remaining second fraction (1-x)T, or less than or equal to five percent of the remaining second fraction (1-x)T. For example, the time interval, T, may be one hundred milliseconds, and the value of x may be 0.05 in some implementations, to meet both the power budget and time allocation parameters. For example, sleep state monitoring with these duty cycle parameters (e.g., T=one hundred milliseconds and x=0.05) may result in a range loss of less than one mile in twenty four hours of sleep state monitoring, for an electric vehicle that is powered by the battery 110.

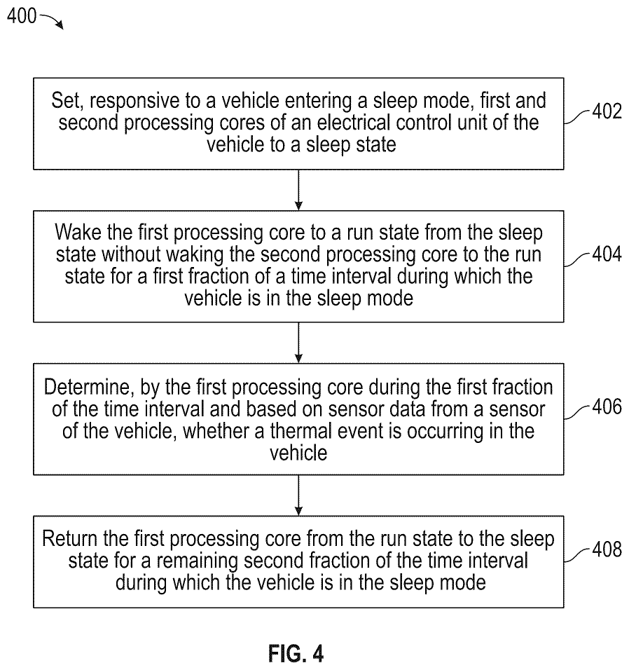

FIG. 4 illustrates a flow diagram of an example process for performing sleep state monitoring for a vehicle, in accordance with implementations of the subject technology. For explanatory purposes, the process 400 is primarily described herein with reference to the vehicle 100, the sensor(s) 104, and the processing circuitry 108 of FIGS. 1A-2. However, the process 400 is not limited to the vehicle 100, the sensor(s) 104, and the processing circuitry 108 of FIGS. 1A-2, and one or more blocks (or operations) of the process 400 may be performed by one or more other components of other suitable moveable apparatuses, devices, or systems. Further for explanatory purposes, some of the blocks of the process 400 are described herein as occurring in serial, or linearly. However, multiple blocks of the process 400 may occur in parallel. In addition, the blocks of the process 400 need not be performed in the order shown and/or one or more blocks of the process 400 need not be performed and/or can be replaced by other operations.

As illustrated in FIG. 4, at block 402, responsive to a vehicle (e.g., vehicle 100) entering a sleep mode, first and second processing cores (e.g., processing core 200 and processing core 202) of an electronic control unit (e.g., ECU 201) of the vehicle may be set to a sleep state (e.g., SLEEP in FIG. 3).

At block 404, the first processing core may wake to a run state (e.g., RUN in FIG. 3) from the sleep state without waking the second processing core to the run state for a first fraction (e.g., xT) of a time interval (e.g., T) during which the vehicle is in the sleep mode. The vehicle may remain in the sleep mode for multiple (e.g., many, or hundreds, or thousands) of the time intervals, T. For example, the time interval may be at least ten times smaller than a known duration of a thermal event signature in the sensor data. In one or more implementations, the first fraction is less than ten percent of a remaining second fraction (e.g., (1-x)T) of the time interval. In one or more implementations, the time interval is based on the known duration and a sleep mode power budget for the sleep mode of the vehicle. For example, the first fraction may be based on the sleep mode power budget, a first time allocation (e.g., t1) for communicating with a sensor (e.g., obtaining sensor data from a sensor 104), a second time allocation (e.g., t2) for processing the sensor data, and a third time allocation (e.g., t3) for performing detection operations using the processed sensor data. In one or more implementations, the sensor includes a pressure sensor, and the thermal event signature includes a pressure variation signature associated with the thermal event.

At block 406, the first processing core may determine, during the first fraction of the time interval and based on sensor data from a sensor (e.g., sensor 104) of the vehicle, whether a thermal event is occurring in the vehicle. In one or more implementations, the process 400 may also include waking the second processing core to an idle state (e.g., IDLE in FIG. 3) from the sleep state for the first fraction of the time interval during which the vehicle is in the sleep mode.

At block 408, the first processing core may (e.g., if no thermal event is detected at block 406) return from the run state to the sleep state for a remaining second fraction (e.g., (1-x)T) of the time interval during which the vehicle is in the sleep mode. In one or more implementations, the process 400 may also include returning the second processing core from the idle state to the sleep state for the remaining second fraction of the time interval during which the vehicle is in the sleep mode. In one or more implementations, responsive to determining, by the first processing core during the first fraction of the time interval and based on sensor data from the sensor of the vehicle, that the thermal event is occurring in the vehicle, an alert may be provided (e.g., over a wired or wireless connection, such as directly or over a network) from the vehicle to a device (e.g., device 109) of a user (e.g., a user of the device 109 and/or the vehicle 100).

In one or more implementations, the process 400 may also include waking a third processing core (e.g., processing core 204) to the idle state from the sleep state for the first fraction of the time interval during which the vehicle is in the sleep mode; and returning the third processing core from the idle state to the sleep state for the remaining second fraction of the time interval during which the vehicle is in the sleep mode.

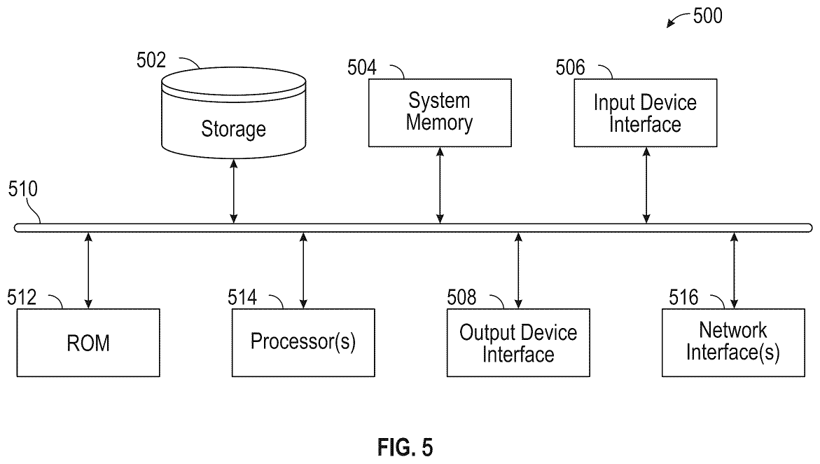

FIG. 5 illustrates an example computing system 500 with which aspects of the subject technology may be implemented in accordance with one or more implementations. The computing system 500 can be, and/or can be a part of, any computing device or apparatus for generating the features and processes described above, including but not limited to control circuitry for a vehicle, and the like. The computing system 500 may include various types of computer readable media and interfaces for various other types of computer readable media. The computing system 500 includes a permanent storage device 502, a system memory 504 (and/or buffer), an input device interface 506, an output device interface 508, a bus 510, a ROM 512, one or more processing unit(s) 514, one or more network interface(s) 516, and/or subsets and variations thereof.

The bus 510 collectively represents all system, peripheral, and chipset buses that communicatively connect the numerous internal devices of the computing system 500. In one or more implementations, the bus 510 communicatively connects the one or more processing unit(s) 514 with the ROM 512, the system memory 504, and the permanent storage device 502. From these various memory units, the one or more processing unit(s) 514 retrieves instructions to execute and data to process in order to execute the processes of the subject disclosure. The one or more processing unit(s) 514 can be a single processor or a multi-core processor in different implementations.

The ROM 512 stores static data and instructions that are needed by the one or more processing unit(s) 514 and other modules of the computing system 500. The permanent storage device 502, on the other hand, may be a read-and-write memory device. The permanent storage device 502 may be a non-volatile memory unit that stores instructions and data even when the computing system 500 is off. In one or more implementations, a mass-storage device (such as a magnetic or optical disk and its corresponding disk drive) may be used as the permanent storage device 502.

In one or more implementations, a removable storage device (such as a flash drive) may be used as the permanent storage device 502. Like the permanent storage device 502, the system memory 504 may be a read-and-write memory device. However, unlike the permanent storage device 502, the system memory 504 may be a volatile read-and-write memory, such as random-access memory. The system memory 504 may store any of the instructions and data that one or more processing unit(s) 514 may need at runtime. In one or more implementations, the processes of the subject disclosure are stored in the system memory 504, the permanent storage device 502, and/or the ROM 512. From these various memory units, the one or more processing unit(s) 514 retrieves instructions to execute and data to process in order to execute the processes of one or more implementations.

The bus 510 also connects to the input and output device interfaces 506 and 508. The input device interface 506 enables a user to communicate information and select commands to the computing system 500. Input devices that may be used with the input device interface 506 may include, for example, alphanumeric keyboards and pointing devices (also called “cursor control devices”). The output device interface 508 may enable, for example, the display of images generated by computing system 500. Output devices that may be used with the output device interface 508 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 5, the bus 510 also couples the computing system 500 to one or more networks and/or to one or more network nodes through the one or more network interface(s) 516. In this manner, the computing system 500 can be a part of a network of devices (such as a LAN, a wide area network (“WAN”), or an Intranet, or a network of networks, such as the Internet). Any or all components of the computing system 500 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S. C. § 112(f), unless the element is expressly recited using the phrase “means for” or, in the case of a method claim, the element is recited using the phrase “step for”.

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A method, comprising:
setting, responsive to a vehicle entering a sleep mode, first and second processing cores of an electronic control unit of the vehicle to a sleep state;
waking the first processing core to a run state from the sleep state without waking the second processing core to the run state for a first fraction of a time interval during which the vehicle is in the sleep mode;
determining, by the first processing core during the first fraction of the time interval and based on sensor data from a sensor of the vehicle, whether a thermal event is occurring in the vehicle; and
returning the first processing core from the run state to the sleep state for a remaining second fraction of the time interval during which the vehicle is in the sleep mode.

2. The method of claim 1, wherein the time interval is at least ten times smaller than a known duration of a thermal event signature in the sensor data.

3. The method of claim 2, wherein the sensor comprises a pressure sensor, and wherein the thermal event signature comprises a pressure variation signature associated with the thermal event.

4. The method of claim 3, wherein the first fraction is less than ten percent of the remaining second fraction.

5. The method of claim 4, wherein the time interval is based on the known duration and a sleep mode power budget for the sleep mode of the vehicle.

6. The method of claim 5, wherein the first fraction is based on the sleep mode power budget, a first time allocation for communicating with the sensor, a second time allocation for processing the sensor data, and a third time allocation for performing detection operations using the processed sensor data.

7. The method of claim 1, further comprising:
waking the second processing core to an idle state from the sleep state for the first fraction of the time interval during which the vehicle is in the sleep mode; and
returning the second processing core from the idle state to the sleep state for the remaining second fraction of the time interval during which the vehicle is in the sleep mode.

8. The method of claim 7, further comprising:
waking a third processing core to the idle state from the sleep state for the first fraction of the time interval during which the vehicle is in the sleep mode; and
returning the third processing core from the idle state to the sleep state for the remaining second fraction of the time interval during which the vehicle is in the sleep mode.

9. The method of claim 1, further comprising:
responsive to determining, by the first processing core during the first fraction of the time interval and based on sensor data from the sensor of the vehicle, that the thermal event is occurring in the vehicle, providing an alert from the vehicle to a device of a user.

10. An electronic control unit for a vehicle, the electronic control unit comprising:
a first processing core; and
a second processing core,
wherein the first and second processing cores are configured to enter a sleep state responsive to the vehicle entering a sleep mode,
wherein the first processing core is configured to:
enter a run state from the sleep state without waking the second processing core to the run state for a first fraction of a time interval during which the vehicle is in the sleep mode;
determine, during the first fraction of the time interval and based on sensor data from a sensor of the vehicle, whether a thermal event is occurring in the vehicle; and
return from the run state to the sleep state for a remaining second fraction of the time interval during which the vehicle is in the sleep mode.

11. The electronic control unit of claim 10, wherein the time interval is at least ten times smaller than a known duration of a thermal event signature in the sensor data.

12. The electronic control unit of claim 11, wherein the sensor comprises a pressure sensor, and wherein the thermal event signature comprise a pressure variation signature associated with the thermal event.

13. The electronic control unit of claim 12, wherein the first fraction is less than ten percent of the remaining second fraction.

14. The electronic control unit of claim 13, wherein the time interval is based on the known duration and a sleep mode power budget for the sleep mode of the vehicle.

15. The electronic control unit of claim 14, wherein the first fraction is based on the sleep mode power budget, a first time allocation for communicating with the sensor, a second time allocation for processing the sensor data, and a third time allocation for performing detection operations using the processed sensor data.

16. The electronic control unit of claim 10, wherein the second processing core is configured to:
transition to an idle state from the sleep state for the first fraction of the time interval during which the vehicle is in the sleep mode; and
return from the idle state to the sleep state for the remaining second fraction of the time interval during which the vehicle is in the sleep mode.

17. The electronic control unit of claim 16, further comprising a third processing core, wherein the third processing core is configured to:
transition to the idle state from the sleep state for the first fraction of the time interval during which the vehicle is in the sleep mode; and
return from the idle state to the sleep state for the remaining second fraction of the time interval during which the vehicle is in the sleep mode.

18. The electronic control unit of claim 10, wherein at least one of the first processing core, the second processing core or a third processing core of the electronic control unit is configured to:
responsive to determining, by the first processing core during the first fraction of the time interval and based on sensor data from the sensor of the vehicle, that the thermal event is occurring in the vehicle, provide an alert for transmission from the vehicle to a device of a user.

19. An electric vehicle, comprising:
an electronic control unit comprising:
a first processing core; and
a second processing core,
wherein the first and second processing cores are configured to enter a sleep state responsive to the electric vehicle entering a sleep mode,
wherein the first processing core is configured to:
enter a run state from the sleep state without waking the second processing core to the run state for a first fraction of a time interval during which the electric vehicle is in the sleep mode;
determine, during the first fraction of the time interval and based on sensor data from a sensor of the electric vehicle, whether a thermal event is occurring in the electric vehicle; and
return from the run state to the sleep state for a remaining second fraction of the time interval during which the electric vehicle is in the sleep mode.

20. The electric vehicle of claim 19, wherein at least one of the first processing core, the second processing core or a third processing core of the electronic control unit is configured to:
responsive to determining, by the first processing core during the first fraction of the time interval and based on sensor data from the sensor of the vehicle, that the thermal event is occurring in the vehicle, provide an alert for transmission from the vehicle to a device of a user.
